(19) United States
(12) Patent Application Publication
(10) Pub. No.: US 2026/0046617 A1
(43) Pub. Date: Feb. 12, 2026

(54) NETWORK AUTHENTICATION USING UE SIM VERIFICATION

(71) Applicant: T-Mobile USA, Inc., Bellevue, WA (US)

(72) Inventors: William WHEAT, Greenbank, WA (US); Rahul Raj, Bellevue, WA (US)

(21) Appl. No.: 18/799,977

(22) Filed: Aug. 9, 2024

(51) Int. Cl. H04W 12/06; H04W 12/72

(52) U.S. Cl. CPC H04W 12/06; H04W 12/72

(57) ABSTRACT

Network authentication, that is more resistant to cyberattacks, uses verification of subscriber identity modules (SIMs) in user equipment (UEs) such as cellphones. A person visits a website with a computer, or calls customer service, to access their user account and their UE receives an interaction identifier (ID) that includes a session ID, an identifier of the customer ID or their UE, and a time indicator. This may be in the form of a QR code displayed on the computer screen or a text message from customer service. The UE forwards the interaction ID to a verification website, providing the IP address or ID stored in the SIM. The verification website compares the UE-provided information with what has been stored earlier by the UE's home wireless carrier to verify the SIM in the UE, providing a proxy for verifying the identity of the person.

### BACKGROUND

Websites that provide access to user accounts commonly use cellphones (or user equipment, UE) in two factor authentication, in which a one time PIN is sent to the cellphone, in order to increase confidence that a legitimate account holder is attempting to log in. A one time PIN, sent to a cellphone (e.g., in a text message) is used a proxy for verifying the identity of the person who purports to be the owner of the account. What is truly being verified in this arrangement, however, is the presence of the subscriber identity module (SIM), because the SIM can be moved around among different cellphones. It is the SIM that determines which cellphone (or user equipment, UE) that receives the one time PIN.

Unfortunately, social engineering enables cyber attacks that permit bad actors to intercept and submit the one time PIN, defeating the purpose of the two factor authentication. This then may result in the bad actors making changes to a victim's user account, such as adding or removing lines, or changing authorized devices in a cellular account. A 2-actor man-in-the-middle attack is able to defeat a one time PIN identity verification scheme. One scenario uses the following ploy: The first actor attempts to log into the users account using the target website, pretending to be the victim. The website transmits a one time PIN to the victim (e.g., by text message to the victim's cellphone) to use for the two factor authentication.

The second actor is in contact with the victim and tricks the victim into revealing the one time PIN, such as by pretending to be an employee of the organization operating the website and providing the user account. Upon obtaining the one time PIN from the victim, the second actor relays the one time PIN to the first actor, who provides it to the website. The website, seeing the two factor authentication satisfied, grants access to the first actor, who then makes the unauthorized changes.

### SUMMARY

The following summary is provided to illustrate examples disclosed herein, but is not meant to limit all examples to any particular configuration or sequence of operations.

Solutions are disclosed that provide more reliable network authentication via user equipment (UE) subscriber identity module (SIM) verification. Examples receive, by a user equipment (UE), an IP address of a verification website and an interaction identifier (ID), the interaction ID comprising a session ID, a customer ID or a UE identification, and a time indicator; transmit, by the UE, to the verification website, the interaction ID and an identifier associated with the UE; extract, by the verification website, from the interaction ID, the session ID, the customer ID or a UE identification, and the time indicator; based on at least determining that the session ID is not expired, determine that the identifier associated with the UE matches a stored identifier in the SIM address list; and based on at least determining that the identifier associated with the UE matches the stored identifier in the SIM address list, transmit, by the verification website, to a second website, a website authentication message.

### BRIEF DESCRIPTION OF THE DRAWINGS

The disclosed examples are described below with reference to the accompanying drawing figures listed below, wherein:

FIG. 1 illustrates an exemplary architecture that advantageously provides a more reliable network authentication via user equipment (UE) subscriber identity module (SIM) verification;

FIG. 2 illustrates an exemplary verification scenario, as may be used in examples of the architecture of FIG. 1;

FIGS. 3A-3C together illustrate a flowchart of exemplary operations associated with the architecture of FIG. 1;

FIG. 4 illustrates further detail for a user computing device used in examples of the architecture of FIG. 1;

FIG. 5 illustrates further detail for the UE of FIG. 1;

FIG. 6 illustrates further detail for a remote website used for verification in examples of the architecture of FIG. 1;

FIG. 7 illustrates a flowchart of exemplary operations associated with the architecture of FIG. 1; and FIG. 8 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Network authentication, that is more resistant to cyber attacks, uses verification of subscriber identity modules (SIMs) in user equipment (UEs) such as cellphones. A person visits a website with a computer, or calls a customer service, to access their user account and their UE receives an interaction identifier (ID) that includes a session ID, an identifier of the customer ID or their UE, and a time indicator. This may be in the form of a QR code displayed on the computer screen or a text message from customer service. The UE forwards the interaction ID to a verification website, providing the IP address or ID stored in the SIM. The verification website compares the UE-provided information with what has been stored earlier by the UE's home wireless carrier to verify the SIM in the UE, providing a proxy for verifying the identity of the person.

Aspects of the disclosure improve the reliability of network authentication by providing a process that is more resistant to cyber attacks than the traditional one time PIN security solution. These advantageous results are accomplished, at least in part, by based on at least determining that the IP address of a UE matches a stored IP address in a SIM address list or determining that the identifier of a SIM (in the UE) matches a stored SIM ID in the SIM address list, transmitting, by a verification website, to a second website, a website authentication message.

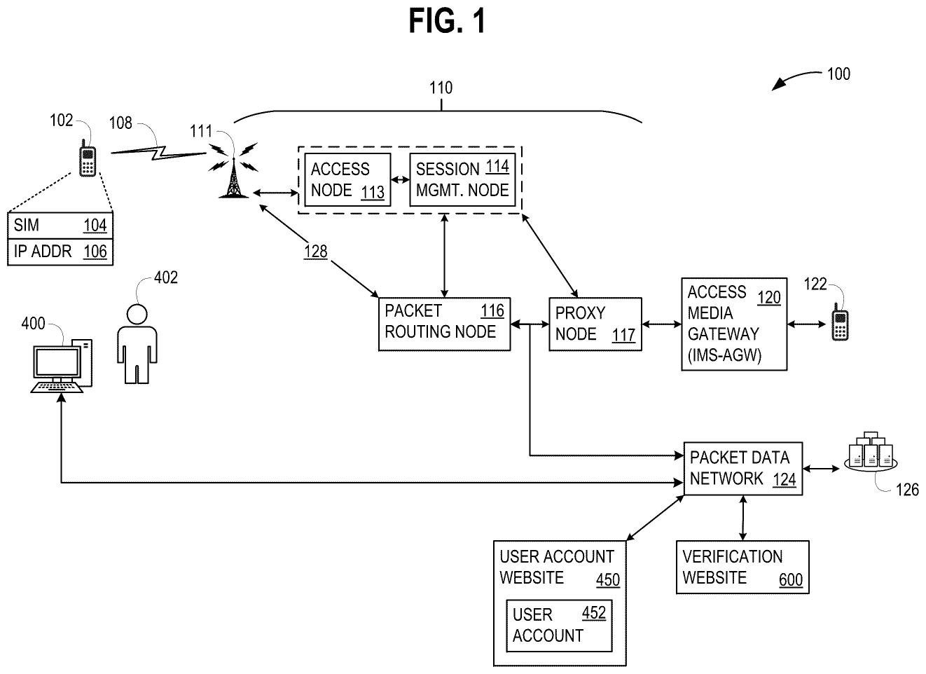

With reference now to the figures, FIG. 1 illustrates an exemplary architecture 100 that advantageously enable verification of the presence of a SIM, as is represented by the purported owner, without requiring that the SIM be removed from the UE. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k. a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

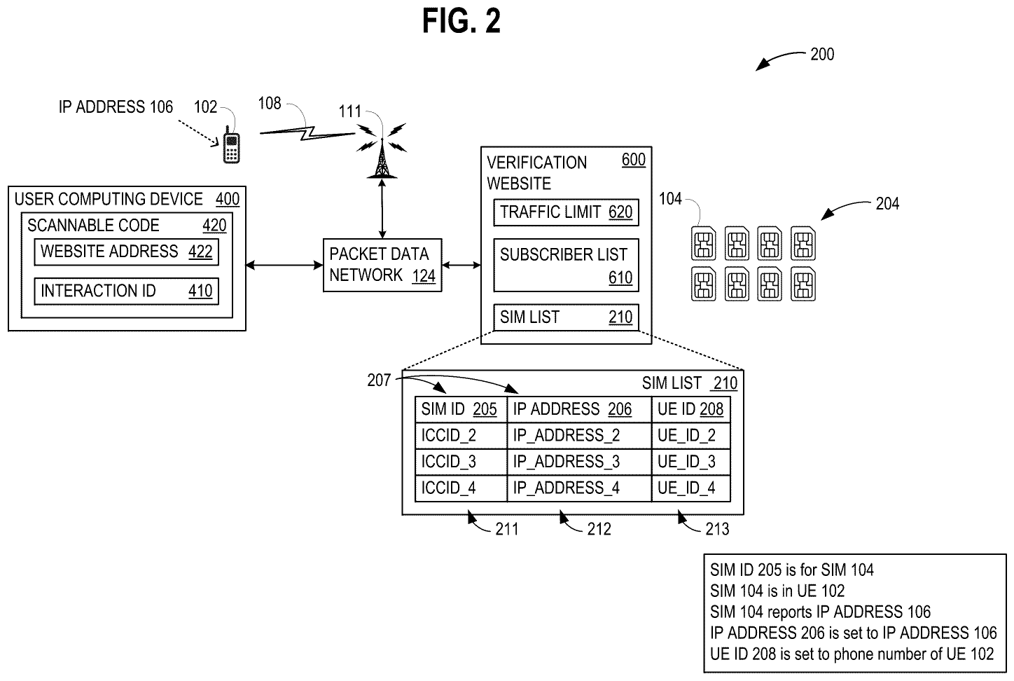

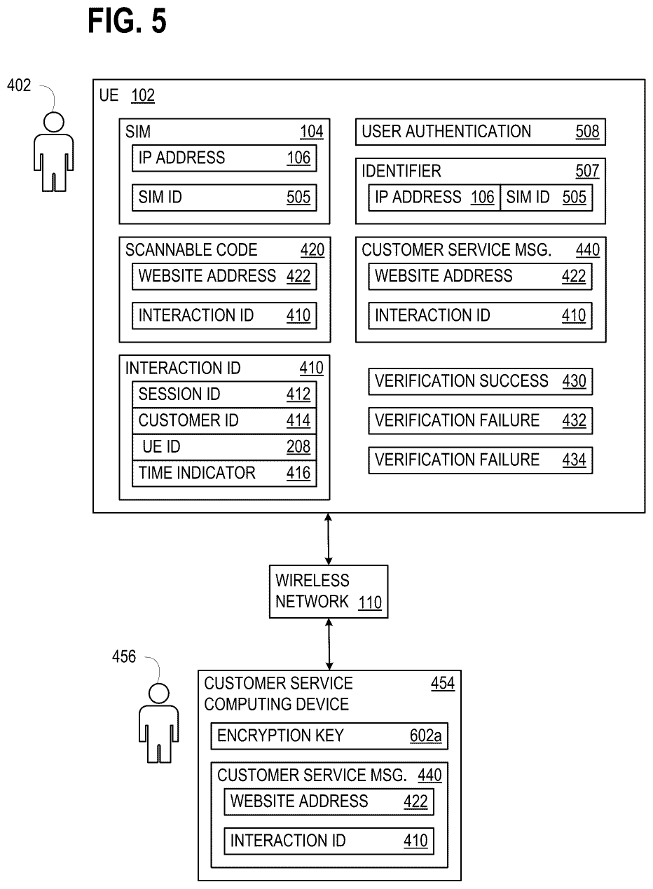

In a verification scenario, illustrated in further detail in FIG. 2 and described more fully below, in relation to the other figures, UE 102 has a SIM 104 and is assigned an IP address 106. An account holder 402 is using a user computing device 400 to make changes to a user account 452 on a website 450. User computing device 400 may be, for example, a tablet computer, a notebook computer, or a desktop computer. Alternatively, account holder 402 may call a customer service entity 456 to make account changes (as shown later, in FIG. 5). A verification website 600 provides verification functionality so that website 450 (or customer service entity 456) is able to trust that the purported account holder actually possesses UE 102 with SIM 104. This is a proxy for trusting that the purported owner of UE 102 is actually the account holder 402. User computing device 400 reaches verification website 600 by any practical means, WiFi, cellular, or even a wired connection.

Although FIG. 1 and some of the following figures are described using an example of a cellular network, it should be understood that the teachings herein are applicable to other types of wireless networks. To benefit from the teachings herein, another service provider, beyond a cellular service provider, that manages accounts for its customers should have usage privileges for verification website 600, or otherwise have access to a SIM address list 210 (described below, in relation to FIG. 2). With such privilege or data access, another type of service provider, other than a cellular network, may also benefit from the disclosure herein.

FIG. 2 illustrates an exemplary verification scenario 200. The cellular service provider provisions a plurality of SIMs 204 for its customers, such as by loading them with unique IP addresses, and generating a SIM address list 210. The SIMS of plurality of SIMs 204 may each be a physical SIM card (pSIM) or an embedded SIM (eSIM). SIM address list 210 is shown in the form of a table with three columns: stored SIM identifiers (IDs) 211 that each uniquely reference a SIM, stored IP addresses 212 (at least one per SIM), and stored UE identifications 213 (at least one per UE).

In some examples, each of SIM IDs 211 comprises an integrated circuit card identifier (ICCID). In some scenarios, the IP addresses assigned to plurality of SIMs 204 are rotated, although remain unique. IP address rotation is a process in which the IP address of a device (i.e., its unique identifier on an IP network) changes at scheduled intervals, after a certain amount of requests, or on some other trigger event. Stored UE identifications 213 may be phone numbers, in some examples.

Each row of SIM address list 210 is unique to a SIM, as shown. SIM 104 is represented within SIM address list 210 by a stored SIM ID 205, which is associated with a stored IP address 206 and a stored UE identification 208. Stored IP address 206 is set to the same value as IP address 106, and stored UE identification 208 is set to the phone number (or some other suitable identification) of UE 102. Either stored IP address 206 or stored UE identification 208 may be used as a stored identifier 207 in SIM address list 210.

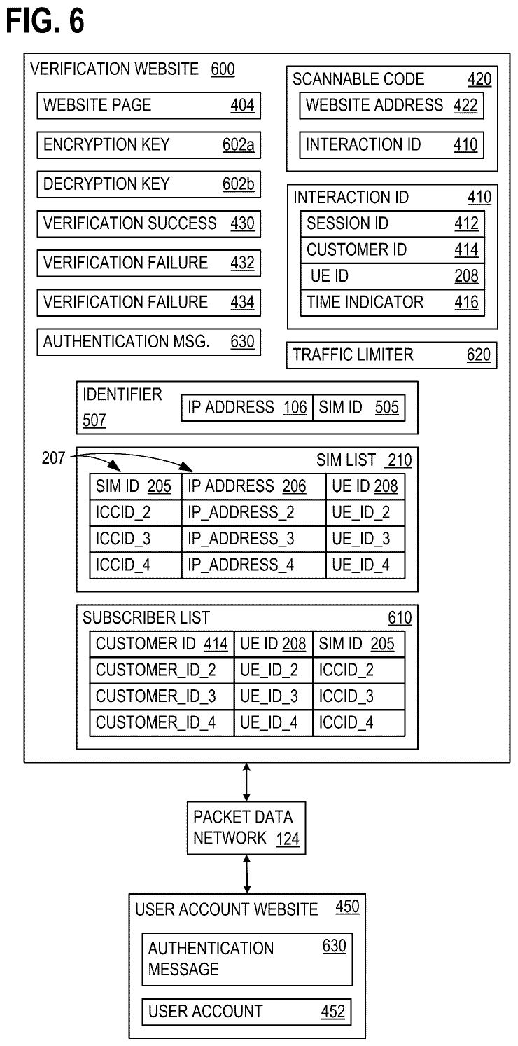

A copy of SIM address list 210 is either stored at, or otherwise accessible by, verification website 600, which located across packet data network 124 from UE 102 and user computing device 400. In some examples, verification website 600 is another example of network resource 126 of FIG. 1, and packet data network 124 is an example of external network 860 of FIG. 9. Verification website 600 also has a subscriber list 610, and a traffic limiter 620, which are shown in further detail in FIG. 6.

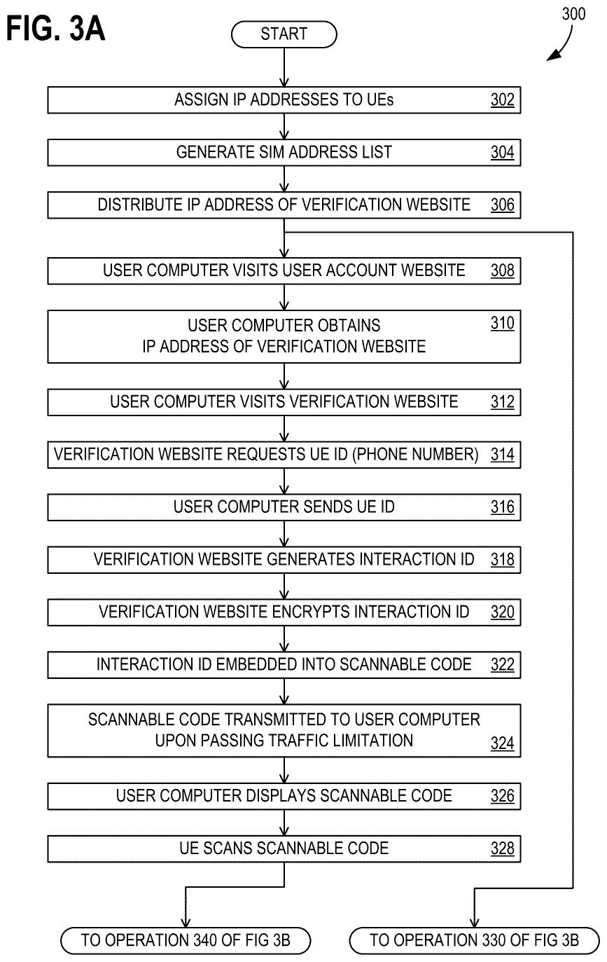

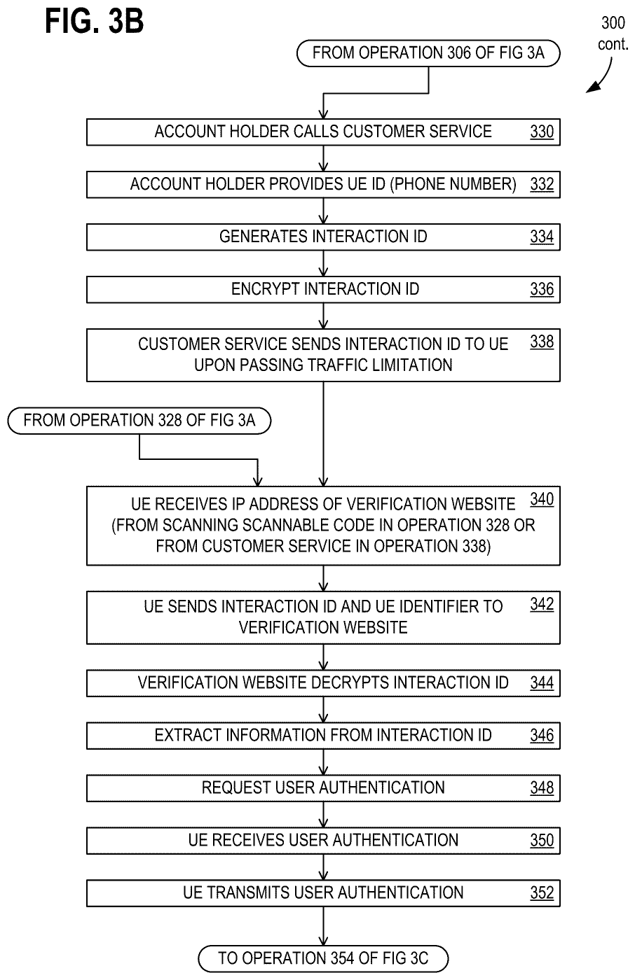

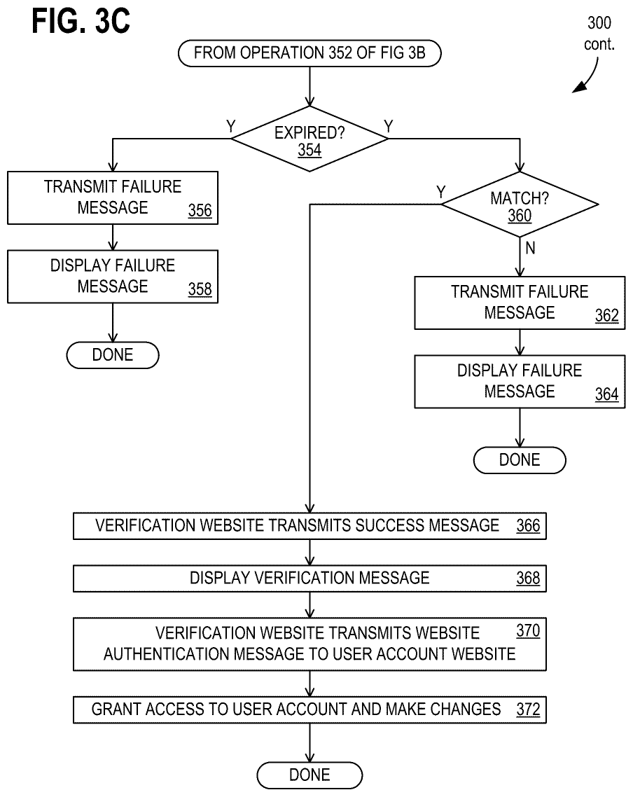

User computing device 400 visits verification website 600 using packet data network 124 and, and described below, receives a scannable code 420 from verification website 600 that has embedded an IP address 422 of verification website 600 and an interaction ID 410 that is described in further detail in relation to FIGS. 3A-3C.

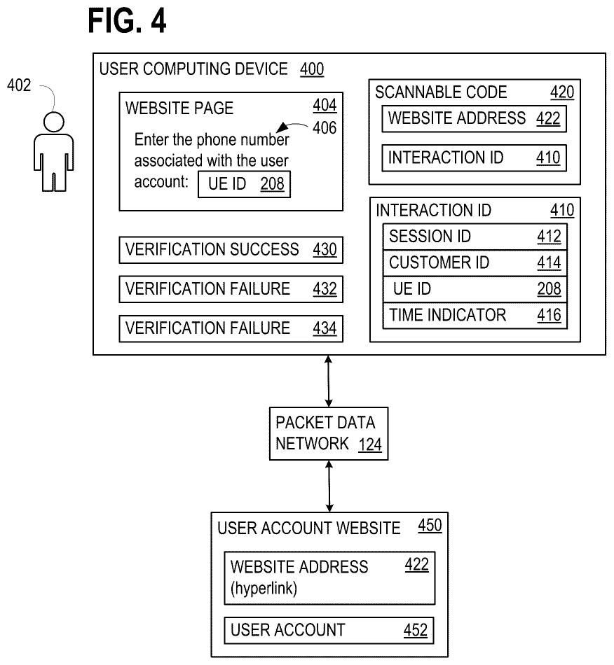

In order to perform the verification, the processes described in relation to flowchart 300 of FIGS. 3A-3C is performed. In some examples, at least a portion of flowchart 300 may be performed using one or more computing devices 800 of FIG. 8. FIGS. 4, 5, and 6 illustrates further detail for user computing device 400, UE 102, and verification website 600, respectively. As FIGS. 3A-3C are described, references are made to the details illustrated in one or more of FIGS. 4, 5, and 6 for a respective one of user computing device 400, UE 102, and verification website 600.

Flowchart 300 commences with assigning unique IP addresses to UEs, including assigning IP address 106 to UE 102, which then associates IP address 106 with SIM 104, in operation 302 of FIG. 3A. Operation 304 generates SIM address list 210 which associates stored SIM IDs (e.g., ICCIDs) with both stored IP addresses and stored UE identifications (e.g., UE phone numbers) for each SIM of plurality of SIMs 204. SIM 104 is placed within UE 102. See FIG. 5.

Operation 306 distributes IP address 422 of verification website 600, such as by placing a hyperlink in website 450, as shown in FIG. 4. Flowchart 300 then branches for different ways to get IP address 422 and interaction ID 410 to UE 102. In one branch, which uses operations 308-328, account holder 402 uses user computing device 400 to visit website 450. In the other branch, which uses operations 330-338, account holder 402 calls customer service entity 456. Describing the branch with operations 308-328 first, user computing device 400 visits website 450 in operation 308 and receives IP address 422 of verification website 600 from website 450 in operation 310.

Using IP address 422, user computing device 400 visits verification website 600 in operation 312. In operation 314, verification website 600 transmits website page 404 to user computing device 400, which prompts for UE identification 208 (e.g., the phone number of UE 102) using a prompt 406. See FIGS. 4 and 5. Account holder 402 enters UE identification 208 and user computing device 400 transmits UE identification 208 to verification website 600 in operation 316.

In operation 318, verification website 600 generates interaction ID 410 that comprises a session ID 412, a customer ID 414 or UE identification 208, and a time indicator 416. If customer ID 414 is used, verification website 600 determines customer ID 414 using subscriber list 610 and UE identification 208. See FIG. 6. Customer ID 414 comprises an identification of account holder 402, who is associated with UE 102. In some examples, time indicator 416 comprises the current time and date or a session expiration time and date.

Verification website 600 encrypts interaction ID 410 using encryption key 602a (shown in FIG. 6) in operation 320 and embeds IP address 422 and interaction ID 410 into scannable code 420 in operation 322, as shown in FIG. 6. In some examples, scannable code 420 comprises a QR code or a 2D barcode. In some examples, traffic limiter 620 limits access to scannable code 420 by preventing uncontrolled distribution of scannable code 420 to any requester. This is because a malicious actor may attempt to create a spoofed version of verification website 600, and so would need to provide a functioning copy of scannable code 420 in order to maintain the ruse (i.e., the victim visits the spoof website, the spoof website requests and receives scannable code 420, and then provides scannable code 420 to the victim in order to maintain the deception).

Multiple security options exist such as, in operation 322, rather than verification website 600 generating scannable code 420, computing device 400 instead generates scannable code 420 using a shared secret between computing device 400 and verification website 600, which an intervening spoof website will not have. Another option is that, in operation 322, verification website 600 transmits scannable code 420 to user computing device 400 through a firewall or other traffic protection solution. UE 102 then scans scannable code 420 in operation 328. See FIGS. 4 and 5.

User computing device 400 displays scannable code 420 in operation 326, and may also display a notice to turn off WiFi and/or to turn on cellular data. The reason for this is that if UE 102 uses cellular data to reach verification website 600, IP address 106 of UE 102 is sent to verification website 600, whereas if UE 102 uses a WiFi router to reach verification website 600, the IP address 106 of the WiFi router may be sent to verification website 600. The IP address of the WiFi router will not be in SIM address list 210, possibly resulting in a SIM verification process failure.

In the other branch of flowchart 300, starting with operation 330 of FIG. 3B, account holder 402 of UE 102 calls customer service entity 456, such as a customer service representative. Account holder 402 provides UE identification 208 to customer service entity 456 in operation 332. Either a customer service computing device 454 generates interaction ID 410, or verification website 600 generates interaction ID 410 and provides it to customer service computing device 454, in operation 334. Customer service computing device 454 encrypts interaction ID 410 using encryption key 602a in operation 336, or alternatively, verification website 600 encrypts interaction ID 410 prior to providing it to customer service computing device 454. See FIG. 5.

Customer service computing device 454 then transmits IP address 422 of verification website 600 and interaction ID 410 to UE 102 in a customer service message 440 (e.g., an SMS message, an MMS message, or an email) in operation 338, as shown in FIG. 5. In some examples, traffic limiter (of FIG. 6) only transmits interaction ID 410 to UE 102 upon further verification that UE 102 is actually the requesting device. For example, verification website 600 may request user authentication 508 (similarly to as in operation 348, which is described below), and only transmit transmits interaction ID 410 to UE 102 upon receiving and verifying user authentication 508.

The different branches merge, resulting in UE 102 receiving IP address 422 of verification website 600 and interaction ID 410 in operation 340. This may be accomplished, by UE 102 extracting IP address 422 of verification website 600 and interaction ID 410 from scannable code 420, or by UE 102 extracting IP address 422 of verification website 600 and interaction ID 410 from customer service message 440. See FIG. 5. In operation 342, UE 102 uses IP address 422 to transmit interaction ID 410 and an identifier 507 associated with UE 102 to verification website 600, interaction ID 410 and the identifier associated with UE 102. Identifier 507 may be IP address 106 of UE 102 or identifier 505 of SIM 104.

Because UE 102 has SIM 104, UE 102 uses IP address 106 as its IP address when visiting websites via cellular data, and is also able to use extensible authentication protocol authentication and key agreement (EAP-AKA) protocol to extract and share identifier 505 of SIM 104. See FIG. 5. In operation 344, verification website 600 decrypts interaction ID 410 using decryption key 602b, shown in FIG. 6. In some examples, encryption key 602a and decryption key 602b are a common symmetric encryption key or are each part of a common key pair.

In operation 346, verification website 600 extracts session ID 412, customer ID 414 or UE identification 208, and time indicator 416 from interaction ID 410. In some examples, verification website 600 requests user authentication 508 from UE 102 in operation 348. UE 102 receives user authentication 508 in operation 350, and transmits user authentication 508 to verification website 600 in operation 352. See FIG. 5. In some examples, when requesting user authentication 508 from UE 102, verification website 600 may include a warning that, if the user (i.e., account holder 402) had not been initiating a change to user account 452, then the process may have been initiated by a malicious actor, and so account holder 402 should only provide user authentication 508 if account holder 402 is actually trying to make a change to user account 452.

In decision operation 354, verification website 600 uses time indicator 416 to determine whether session ID 412 is expired. If session ID 412 is expired, verification website 600 transmits a verification failure message 432 to UE 102 and/or to user computing device 400 in operation 356, and UE 102 and/or user computing device 400 display verification failure message 432 in operation 358. See FIGS. 4, 5, and 6. Verification failure message 432 may indicate that the SIM verification process failed, and may possibly further indicate that the failure is due to the session expiring. Flowchart 300 then terminates.

If, however, session ID 412 is not expired, in decision operation 360 verification website 600 determines whether identifier 507 matches stored identifier 207 in SIM address list 210. When identifier 507 is IP address 106, stored identifier 207 is stored IP address 206, and when identifier 507 is identifier 505 of SIM 104, stored identifier 207 is stored SIM ID 205. If there is no match, verification website 600 transmits a verification failure message 434 to UE 102 and/or to user computing device 400 in operation 362, and UE 102 and/or user computing device 400 display verification failure message 434 in operation 364. See FIGS. 4, 5, and 6. Verification failure message 434 may indicate a notice to turn off WiFi and/or to turn on cellular data, because the failure may be due to verification website 600 receiving the IP address of a WiFi router used by UE 102. Flowchart 300 then terminates.

If, however, decision operation 360 determines that identifier 507 matches stored identifier 207 (i.e., IP address 106 matches stored IP address 206, or identifier 505 of SIM 104 matches stored SIM ID 205), verification website 600 transmits a verification message 430 to UE 102 and/or to user computing device 400 in operation 366. UE 102 and/or user computing device 400 display verification message 430 in operation 368. See FIGS. 4, 5, and 6. Verification message 430 is a success message indicating that the SIM verification process is passed.

In operation 370, based on at least determining that identifier 507 matches stored identifier 207, verification website 600 transmits a website authentication message 630 to website 450, which indicates to website 450 that the SIM verification process is passed. See FIG. 6. Website 450 uses this as a proxy for determining that the identity of account holder 402 is verified, and so access may be granted to user account 452 (which is associated with UE 102). See FIGS. 4 and 6. Based on at least website 450 receiving website authentication message 630, a user account change is performed on user account 452, for example, using website 450, in operation 372.

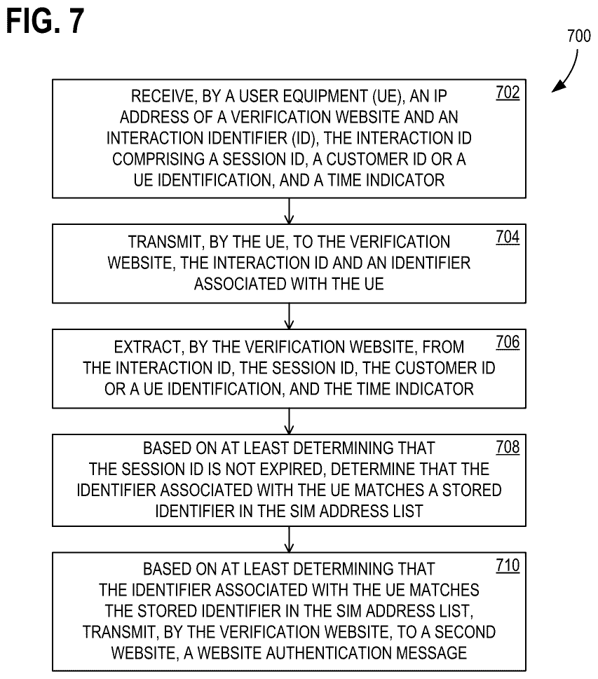

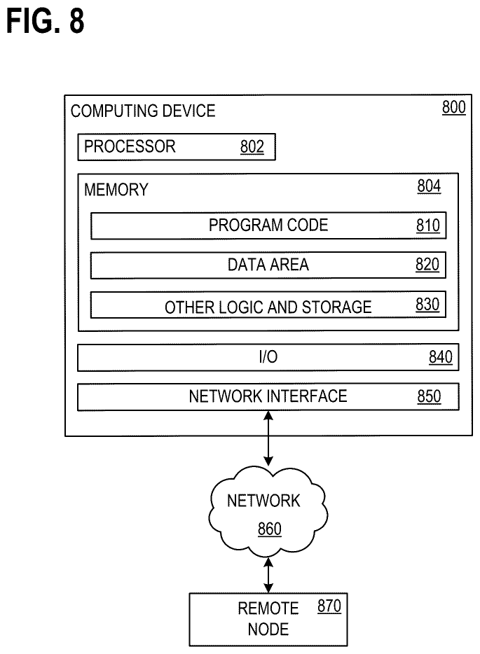

FIG. 7 illustrates a flowchart 700 of exemplary operations associated with architecture 100. In some examples, at least a portion of flowchart 700 may be performed using one or more computing devices 800 of FIG. 8. Flowchart 700 commences with operation 702, which includes receiving, by a UE, an IP address of a verification website and an interaction ID, the interaction ID comprising a session ID, a customer ID or a UE identification, and a time indicator. Operation 704 includes transmitting, by the UE, to the verification website, the interaction ID and an identifier associated with the UE.

Operation 706 includes extracting, by the verification website, from the interaction ID, the session ID, the customer ID or a UE identification, and the time indicator. Operation 708 includes, based on at least determining that the session ID is not expired, determining that the identifier associated with the UE matches a stored identifier in a SIM address list. Operation 710 includes, based on at least determining that the identifier associated with the UE matches the stored identifier in the SIM address list, transmitting, by the verification website, to a second website, a website authentication message.

FIG. 8 illustrates a block diagram of computing device 800 that may be used as any component described herein that may require computational or storage capacity. Computing device 800 has at least a processor 802 and a memory 804 that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, persistent memory devices, and/or optical disks. Program code 810 comprises computer executable instructions and computer executable components including instructions used to perform operations described herein.

Data area 820 holds data used to perform operations described herein. Memory 804 also includes other logic and storage 830 that performs or facilitates other functions disclosed herein or otherwise required of computing device 800. An input/output (I/O) component 840 facilitates receiving input from users and other devices and generating displays for users and outputs for other devices. A network interface 850 permits communication over external network 860 with a remote node 870, which may represent another implementation of computing device 800. For example, a remote node 870 may represent another of the above-noted nodes within architecture 100.

### Additional Examples

An example system comprises: a processor; and a computer-readable medium storing instructions that are operative upon execution by the processor to: receive, by a UE, an IP address of a verification website and an interaction ID, the interaction ID comprising a session ID, a customer ID or a UE identification, and a time indicator; using the IP address of the verification website, transmit, by the UE, to the verification website, the interaction ID and an identifier associated with the UE; extract, by the verification website, from the interaction ID, the session ID, the customer ID or a UE identification, and the time indicator; based on at least determining that the session ID is not expired, determine that the identifier associated with the UE matches a stored identifier in the SIM address list; and based on at least determining that the identifier associated with the UE matches the stored identifier in the SIM address list, transmit, by the verification website, to a second website, a website authentication message.

An example method comprises: receiving, by a UE, an IP address of a verification website and an interaction ID, the interaction ID comprising a session ID, a customer ID or a UE identification, and a time indicator; using the IP address of the verification website, transmitting, by the UE, to the verification website, the interaction ID and an identifier associated with the UE; extracting, by the verification website, from the interaction ID, the session ID, the customer ID or a UE identification, and the time indicator; based on at least determining that the session ID is not expired, determining that the identifier associated with the UE matches a stored identifier in the SIM address list; and based on at least determining that the identifier associated with the UE matches the stored identifier in the SIM address list, transmitting, by the verification website, to a second website, a website authentication message.

One or more example computer storage devices has computer-executable instructions stored thereon, which, upon execution by a computer, cause the computer to perform operations comprising: receiving, by a UE, an IP address of a verification website and an interaction ID, the interaction ID comprising a session ID, a customer ID or a UE identification, and a time indicator; using the IP address of the verification website, transmitting, by the UE, to the verification website, the interaction ID and an identifier associated with the UE; extracting, by the verification website, from the interaction ID, the session ID, the customer ID or a UE identification, and the time indicator; based on at least determining that the session ID is not expired, determining that the identifier associated with the UE matches a stored identifier in the SIM address list; and based on at least determining that the identifier associated with the UE matches the stored identifier in the SIM address list, transmitting, by the verification website, to a second website, a website authentication message.

Alternatively, or in addition to the other examples described herein, examples include any combination of the following:
the wireless network comprises a cellular network;
the UE comprises an eMBB or cellular telephone;
based on at least the second website receiving the website authentication message, performing a user account change, using the second website, on a user account associated with the UE;
each stored IP address is unique;
generating the SIM address list associating, for each SIM of the plurality of SIMs, the stored IP address with a stored UE identification;
the UE identification comprises a phone number of the UE;
the identifier associated with the UE comprises an IP address of the UE or an identifier of a first SIM of the UE;
the stored identifier in the SIM address list comprises a stored IP address in the SIM address list or a stored SIM ID in the SIM address list;
using the time indicator, determining whether the session ID is expired;
based on at least determining that the session ID is expired, transmitting, by the verification website, to the UE and/or to the user computing device, a first verification failure message;
displaying, by the UE and/or the user computing device, the first verification failure message;
determining whether the identifier associated with the UE matches the stored identifier in the SIM address list;
based on at least determining that the identifier associated with the UE does not match a stored identifier in the SIM address list, transmitting, by the verification website, to the UE, the second verification failure message;
displaying, by the UE, the second verification failure message;
visiting, by a user computing device, the verification website;
transmitting, to the user computing device, by the verification website transmits, a website page prompting for the UE identification;
transmitting, by the user computing device, to the verification website, the UE identification;
embedding the IP address of the verification website and the interaction ID into a scannable code;
transmitting, by the verification website, to the user computing device, the scannable code;
displaying, by the user computing device, the scannable code;
scanning, by the UE, the scannable code;
receiving the IP address of the verification website and the interaction ID comprises extracting, by the UE, the IP address of the verification website and the interaction ID from the scannable code;
encrypting the interaction ID using an encryption key;
embedding the interaction ID into the scannable code comprises embedding the encrypted interaction ID into the scannable code;
decrypting the interaction ID using the decryption key;
the encryption key and the decryption key are a common symmetric encryption key or are each part of a common key pair;
requesting, by the verification website, user authentication from the UE;
receiving the user authentication by the UE;
transmitting, by the UE, to the verification website, the user authentication;
determining that the identifier associated with the UE matches the stored identifier in the SIM address list is based on at least the verification website receiving the user authentication from the UE;
visiting, by a user computing device, the second website;
receiving, by the user computing device, from the second website, the IP address of the verification website;
transmitting, by a customer service computing device, to the UE, the IP address of the verification website and the interaction ID in a customer service message;
the SIM address list includes an ICCID for each SIM of the plurality of SIMs;
the identifier of the first SIM comprises an ICCID;
the verification website generates the interaction ID;
the time indicator comprises a current time and date;
the time indicator comprises a session expiration time and date;
the scannable code comprises a QR code or a 2D barcode;
the verification website uses the time indicator to determine whether the session ID is expired;
the first verification failure message indicates that the session ID is expired;
the second verification failure message indicates a notice to turn off WiFi and/or to turn on cellular data;
the verification website encrypts the interaction ID;
the customer service computing device encrypts the interaction ID;
the verification website decrypts the interaction ID;
transmitting, by the verification website, to the UE, a verification message;
the verification message indicates that a SIM verification is passed;
the website authentication message indicates that a SIM verification is passed;
displaying, by the UE, the verification message;
distributing the IP address of the verification website;
distributing the IP address of the verification website comprises placing the hyperlink in the second website;
the user computing device comprises a tablet computer, a notebook computer, or a desktop computer;
the verification website determines the customer ID using the subscriber list and the UE identification;
the customer ID comprises an identification of an account holder associated with the UE;
displaying, by the user computing device, a notice to turn off WiFi and/or to turn on cellular data;
the user of the UE calls a customer service entity;
the user provides the UE identification;
the customer service computing device generates the interaction ID or the customer service computing device receives the interaction ID from the verification website;
the customer service message comprises an SMS or an MMS message or an email; and
the UE extracts the IP address of the verification website and the interaction ID from the customer service message.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving, by a user equipment (UE), an IP address of a verification website and an interaction identifier (ID), the interaction ID comprising a session ID, a customer ID or a UE identification, and a time indicator;
transmitting, by the UE, to the verification website, the interaction ID and an identifier associated with the UE;
extracting, by the verification website, from the interaction ID, the session ID, the customer ID or a UE identification, and the time indicator;
based on at least determining that the session ID is not expired, determining that the identifier associated with the UE matches a stored identifier in a SIM address list; and
based on at least determining that the identifier associated with the UE matches the stored identifier in the SIM address list, transmitting, by the verification website, to a second website, a website authentication message.

2. The method of claim 1, further comprising:
based on at least the second website receiving the website authentication message, performing a user account change, using the second website, on a user account associated with the UE.

3. The method of claim 1, further comprising:
generating the SIM address list associating, for each SIM of the plurality of SIMs, the stored IP address with a stored UE identification, wherein the UE identification comprises a phone number of the UE, wherein the identifier associated with the UE comprises an IP address of the UE or an identifier of the first SIM, and wherein the stored identifier in the SIM address list comprises a stored IP address in the SIM address list or a stored SIM ID in the SIM address list.

4. The method of claim 1, further comprising:
either:
using the time indicator, determining whether the session ID is expired;
based on at least determining that the session ID is expired, transmitting, by the verification website, to the UE and/or to a user computing device, a first verification failure message; and
displaying, by the UE and/or the user computing device, the first verification failure message; or
determining whether the identifier associated with the UE matches the stored identifier in the SIM address list;
based on at least determining that the identifier associated with the UE does not match a stored identifier in the SIM address list, transmitting, by the verification website, to the UE, a second verification failure message; and
displaying, by the UE, the second verification failure message.

5. The method of claim 1, further comprising:
visiting, by a user computing device, the verification website;
transmitting, to the user computing device, by the verification website transmits, a website page prompting for the UE identification;
transmitting, by the user computing device, to the verification website, the UE identification;
generating, by the verification website, the interaction ID;
embedding the IP address of the verification website and the interaction ID into a scannable code;
transmitting, by the verification website, to the user computing device, the scannable code;
displaying, by the user computing device, the scannable code; and
scanning, by the UE, the scannable code, wherein receiving the IP address of the verification website and the interaction ID comprises extracting, by the UE, the IP address of the verification website and the interaction ID from the scannable code.

6. The method of claim 5, further comprising:
encrypting the interaction ID using an encryption key, wherein embedding the interaction ID into the scannable code comprises embedding the encrypted interaction ID into the scannable code; and
decrypting the interaction ID using a decryption key, wherein the encryption key and the decryption key are a common symmetric encryption key or are each part of a common key pair.

7. The method of claim 1, further comprising:
requesting, by the verification website, user authentication from the UE;
receiving the user authentication by the UE; and
transmitting, by the UE, to the verification website, the user authentication, wherein determining that the identifier associated with the UE matches the stored identifier in the SIM address list is based on at least the verification website receiving the user authentication from the UE.

8. The method of claim 1, further comprising:
visiting, by a user computing device, the second website; and
receiving, by the user computing device, from the second website, the IP address of the verification website.

9. The method of claim 1, further comprising:
transmitting, by a customer service computing device, to the UE, the IP address of the verification website and the interaction ID in a customer service message.

10. A system comprising:
a processor; and
a computer-readable medium storing instructions that are operative upon execution by the processor to:
receive, by a user equipment (UE), an IP address of a verification website and an interaction identifier (ID), the interaction ID comprising a session ID, a customer ID or a UE identification, and a time indicator;
transmit, by the UE, to the verification website, the interaction ID and an identifier associated with the UE;
extract, by the verification website, from the interaction ID, the session ID, the customer ID or a UE identification, and the time indicator;
based on at least determining that the session ID is not expired, determine that the identifier associated with the UE matches a stored identifier in a SIM address list; and
based on at least determining that the identifier associated with the UE matches the stored identifier in the SIM address list, transmit, by the verification website, to a second website, a website authentication message.

11. The system of claim 10, wherein the instructions are further operative to:
based on at least the second website receiving the website authentication message, perform a user account change, using the second website, on a user account associated with the UE.

12. The system of claim 10, wherein the instructions are further operative to:
generate the SIM address list associating, for each SIM of the plurality of SIMs, the stored IP address with a stored UE identification, wherein the UE identification comprises a phone number of the UE, wherein the identifier associated with the UE comprises an IP address of the UE or an identifier of the first SIM, and wherein the stored identifier in the SIM address list comprises a stored IP address in the SIM address list or a stored SIM ID in the SIM address list.

13. The system of claim 10, wherein the instructions are further operative to:
either:
using the time indicator, determine whether the session ID is expired;
based on at least determining that the session ID is expired, transmit, by the verification website, to the UE and/or to a user computing device, a first verification failure message; and
display, by the UE and/or the user computing device, the first verification failure message; or
determine whether the identifier associated with the UE matches the stored identifier in the SIM address list;
based on at least determining that the identifier associated with the UE does not match a stored identifier in the SIM address list, transmit, by the verification website, to the UE, a second verification failure message; and
display, by the UE, the second verification failure message.

14. The system of claim 10, wherein the instructions are further operative to:
visit, by a user computing device, the verification website;
transmit, to the user computing device, by the verification website transmits, a website page prompting for the UE identification;
transmit, by the user computing device, to the verification website, the UE identification;
generating, by the verification website, the interaction ID;
embed the IP address of the verification website and the interaction ID into a scannable code;
display, by the user computing device, the scannable code; and
scan, by the UE, the scannable code, wherein receiving the IP address of the verification website and the interaction ID comprises extracting, by the UE, the IP address of the verification website and the interaction ID from the scannable code.

15. The system of claim 10, wherein the instructions are further operative to:
either:
visit, by a user computing device, the second website; and
receive, by the user computing device, from the second website, the IP address of the verification website; or
transmit, by a customer service computing device, to the UE, the IP address of the verification website and the interaction ID.

16. One or more computer storage devices having computer-executable instructions stored thereon, which, upon execution by a computer, cause the computer to perform operations comprising:
receiving, by a user equipment (UE), an IP address of a verification website and an interaction identifier (ID), the interaction ID comprising a session ID, a customer ID or a UE identification, and a time indicator;
transmitting, by the UE, to the verification website, the interaction ID and an identifier associated with the UE;
extracting, by the verification website, from the interaction ID, the session ID, the customer ID or a UE identification, and the time indicator;
based on at least determining that the session ID is not expired, determining that the identifier associated with the UE matches a stored identifier in a SIM address list; and
based on at least determining that the identifier associated with the UE matches the stored identifier in the SIM address list, transmitting, by the verification website, to a second website, a website authentication message.

17. The one or more computer storage devices of claim 16, wherein the operations further comprise:
generating the SIM address list associating, for each SIM of the plurality of SIMs, the stored IP address with a stored UE identification, wherein the UE identification comprises a phone number of the UE, wherein the identifier associated with the UE comprises an IP address of the UE or an identifier of the first SIM, and wherein the stored identifier in the SIM address list comprises a stored IP address in the SIM address list or a stored SIM ID in the SIM address list.

18. The one or more computer storage devices of claim 16, wherein the operations further comprise:
either:
using the time indicator, determining whether the session ID is expired;
based on at least determining that the session ID is expired, transmitting, by the verification website, to the UE and/or to a user computing device, a first verification failure message; and
displaying, by the UE and/or the user computing device, the first verification failure message; or
determining whether the identifier associated with the UE matches the stored identifier in the SIM address list;
based on at least determining that the identifier associated with the UE does not match a stored identifier in the SIM address list, transmitting, by the verification website, to the UE, a second verification failure message; and
displaying, by the UE, the second verification failure message.

19. The one or more computer storage devices of claim 16, wherein the operations further comprise:
visiting, by a user computing device, the verification website;
transmitting, to the user computing device, by the verification website transmits, a website page prompting for the UE identification;
transmitting, by the user computing device, to the verification website, the UE identification;
generating, by the verification website, the interaction ID;
embedding the IP address of the verification website and the interaction ID into a scannable code;
displaying, by the user computing device, the scannable code; and
scanning, by the UE, the scannable code, wherein receiving the IP address of the verification website and the interaction ID comprises extracting, by the UE, the IP address of the verification website and the interaction ID from the scannable code.

20. The one or more computer storage devices of claim 16, wherein the operations further comprise:
either:
visiting, by a user computing device, the second website; and
receiving, by the user computing device, from the second website, the IP address of the verification website; or
transmitting, by a customer service computing device, to the UE, the IP address of the verification website and the interaction ID in a customer service message.
